(19) United States
(12) Patent Application Publication
(10) Pub. No.: US 2026/0311551 A1
(43) Pub. Date: Oct. 8, 2026

(54) VIRTUAL-REAL INTEGRATED SYSTEM APPLIED TO RANDOM PATH GAME

(71) Applicant: JUMBO TECHNOLOGY CO., LTD., TAICHUNG (TW)

(72) Inventors: Shun Tsung HSU, TAICHUNG (TW); Chang Yi WANG, TAICHUNG (TW)

(21) Appl. No.: 19/711,361

(22) Filed: Jun. 17, 2026

Related U.S. Application Data
(63) Continuation-in-part of application No. 19/193,645, filed on Apr. 29, 2025.
Application No. 19/193,645 is a continuation of application No. 19/072,196, filed on Mar. 6, 2025, now abandoned.
Application No. 19/072,196 is a continuation-in-part of application No. 17/915,980, filed on Apr. 1, 2020, now Pat. No. 12,249,214.
Application No. 19/072,196 is a continuation-in-part of application No. 18/251,793, filed on Dec. 3, 2020.

(51) Int. Cl. G07F 17/32; G06T 7/70

(52) U.S. Cl. CPC G07F 17/323; G06T 7/70; G07F 17/3209; G07F 17/3211

(57) ABSTRACT

A virtual-real integrated system applied to a random path game, wherein a real-time image is obtained by capturing a real scene of a physical gaming machine through an image capturing module, the physical gaming machine having a plurality of paths; at least one virtual object image randomly appearing on the plurality of paths is generated by a virtual object generation module; when a game processing module detects that an object movement trajectory of a plurality of physical objects passes through the at least one virtual object image, a trigger event is triggered and a corresponding visual image is generated; and the game processing module controls a virtual-real image synthesis processing module to combine the foregoing images to generate a virtual-real synthesized image, which is displayed in a game screen display area.

### CROSS-REFERENCE TO RELATED APPLICATIONS

This application claims priority to U.S. patent application Ser. No. 18/251,793, filed Dec. 3, 2020, entitled “GAME SYSTEM HAVING IMAGE COMPOSITING DISPLAY”, and U.S. patent application Ser. No. 19/193,645, filed Apr. 29, 2025, entitled “GAME SYSTEM AND METHOD FOR PROVIDING VARIABLE ODDS WITH IMAGE SYNTHESIS DISPLAY.”

U.S. patent application Ser. No. 19/193,645 is a continuation of U.S. patent application Ser. No. 19/072,196, filed Mar. 6, 2025, entitled “GAME SYSTEM FOR PROVIDING VARIABLE ODDS WITH IMAGE SYNTHESIS DISPLAY”, which is a continuation-in-part of U.S. patent application Ser. No. 17/915,980, filed Apr. 1, 2020, entitled “GAMBLING GAME SYSTEM AND METHOD FOR PROVIDING VARIABLE ODDS,” and U.S. patent application Ser. No. 18/251,793, filed Dec. 3, 2020, entitled “GAME SYSTEM HAVING IMAGE COMPOSITING DISPLAY.”

### FIELD OF THE INVENTION

The present application relates to a game system, and more particularly to a virtual-real integrated system applied to a random path game.

### BACKGROUND OF THE INVENTION

In a random path game, a plurality of marbles are generally used in the game. The plurality of marbles are transported from a starting point to an elevated position of a physical gaming machine by mechanical devices, such as an elevator, a launching device, and an air-blowing device. The plurality of marbles are then driven by potential energy as a power source and randomly move along a track on the physical gaming machine toward an end point. A game result is determined according to an order in which the plurality of marbles arrive at the end point. At least one of the plurality of marbles is allowed to be bet on by a player. When the at least one marble arrives at the end point first, a corresponding payout is provided to the player.

As disclosed in U.S. Patent Publication No. US20250213960A1, titled “Randomized marble racing game and remote play of the same,” a marble racing game is provided, in which a player is allowed to make a guess and place a bet on which of a plurality of marbles will reach an end first. When a game result corresponds to the marble on which the bet is placed reaching the end first, a corresponding payout is provided.

Since each game round of the marble racing game takes a long time to complete, approximately 3 to 5 minutes, a player is likely to feel bored during the game process, thereby reducing a willingness of the player to play. In addition, in order to ensure fairness, the marble racing game provides identical starting points and identical end points for the marbles, and identical odds are assigned to the marbles. The marbles use only potential energy as a power source. Accordingly, during a racing process, the marbles are sequentially ordered by randomly colliding with track boundaries or obstacles, and the player can only wait for a final game result. Although fairness is achieved, the racing process is monotonous and the odds are fixed, such that the marble racing game is unlikely to attract the player to play.

### SUMMARY OF THE INVENTION

Accordingly, a primary objective of the present application is to provide a virtual-real integrated system configured to combine and display a real-time image of a physical gaming machine together with a virtual object image, wherein the virtual object image is used to provide additional or extra rewards, thereby attracting a player to continuously pay attention to the game and maintain an interest in the game.

To achieve the object described above, the present application provides a virtual-real integrated system applied to a random path game. The random path game includes a physical gaming machine and a plurality of physical objects. The physical gaming machine has at least one starting point, at least one end point, and a plurality of paths. The plurality of paths respectively connect the at least one starting point and the at least one end point, and the plurality of physical objects respectively move from the at least one starting point to the at least one end point along one of the plurality of paths in a random manner, thereby generating object movement trajectories, and a game result is generated after the plurality of physical objects reach the at least one end point.

The virtual-real integrated system includes a game processing module, an odds processing module, a user interface module, an image capturing module, an image recognition module, a virtual object generation module, a special effect processing module, a virtual-real image synthesis processing module, and a payout module.

The odds processing module is connected to the game processing module. The odds processing module provides a set of payout odds according to real-time positions of the plurality of physical objects. The set of payout odds includes a plurality of payout odds respectively applicable to the plurality of physical objects.

The user interface module is connected to the game processing module, and includes a game screen display area and a plurality of betting areas corresponding to the plurality of physical objects, wherein the game processing module generates betting data based on bets placed on the plurality of betting areas. The betting data includes at least one betting selection corresponding to at least one of the plurality of physical objects, a betting amount, and the set of payout odds.

The image capturing module is connected to the game processing module. The image capturing module captures a real scene of the physical gaming machine to obtain a real-time image and transmits the real-time image to the game processing module. The image recognition module is connected to the game processing module, wherein the game processing module transmits the real-time image to the image recognition module to generate image position information including positions of the physical gaming machine and the plurality of physical objects, and the image recognition module transmits the image position information back to the game processing module.

The virtual object generation module is connected to the game processing module. The virtual object generation module is configured to randomly generate at least one virtual object image appearing on at least one of the plurality of paths after the betting data is generated. Each of the at least one virtual object image has virtual object position information located on the plurality of paths.

The special effect processing module is connected to the game processing module, wherein when the game processing module detects that an object movement trajectory of any of the plurality of physical objects passes through the at least one virtual object image on the plurality of paths, a trigger event is triggered, and the game processing module controls the special effect processing module to provide a corresponding visual image according to an attribute of the virtual object image.

The virtual-real image synthesis processing module is connected to the game processing module, wherein the game processing module transmits the real-time image, the image position information, the at least one virtual object image, the virtual object position information, the visual image, and the betting data to the virtual-real image synthesis processing module, and the game processing module controls the virtual-real image synthesis processing module to generate a virtual-real synthesized image, and the game processing module transmits the virtual-real synthesized image to the user interface module so that the game screen display area displays the virtual-real synthesized image.

The payout module is connected to the game processing module and is configured to perform payout according to the betting data, the game result, and rewards obtained from the trigger event.

### BRIEF DESCRIPTION OF THE DRAWINGS

FIG. 1 is an exemplary diagram of a physical gaming machine to which the present application is applied.

FIG. 2 is an exemplary diagram of another physical gaming machine to which the present application is applied.

FIG. 3 is an exemplary system architecture diagram of the present application.

FIG. 4 is an exemplary schematic diagram of a gaming machine for player operation of the present application.

FIG. 5 is an exemplary diagram of a game screen of the present application.

FIG. 6 is an exemplary diagram of real-time positions of a plurality of physical objects of the present application.

FIG. 7 is an exemplary diagram of real-time updating of payout odds of the present application.

FIG. 8 is an exemplary diagram of a virtual object image of the present application.

FIGS. 9 to 11 are exemplary diagrams of visual images of the present application.

FIG. 12 is an exemplary diagram of a virtual-real synthesized image of the present application.

FIG. 13 is an exemplary diagram of movement of a visual image of the present application.

### DETAILED DESCRIPTION

The detailed description and technical contents of the present application are described below with reference to the drawings.

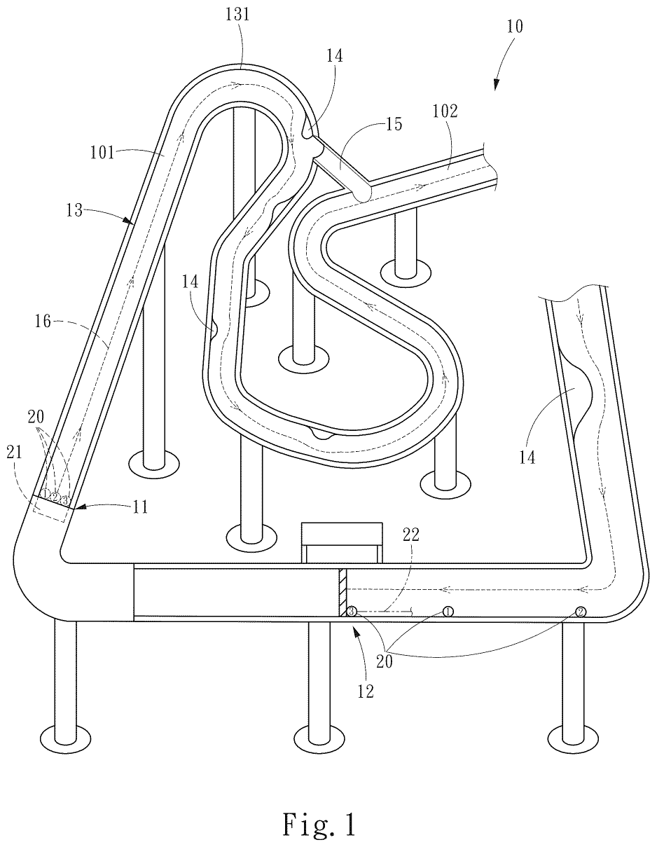

The present application provides a virtual-real integrated system applied to a random path game for a player to play the random path game. A physical gaming machine of the random path game may be provided in various configurations. Referring to FIG. 1, in one embodiment, the random path game includes a physical gaming machine 10 and a plurality of physical objects 20.

As shown in FIG. 1, the plurality of physical objects 20 are a plurality of marbles, and three marbles are illustrated in the drawing as an example. The physical gaming machine 10 includes an ascending slope section 101 and a descending slope section 102 connected to each other. The ascending slope section 101 is configured to have a starting point 11, and the descending slope section 102 is configured to have an end point 12. A track 13 is provided between the starting point 11 and the end point 12. A plurality of obstacles 14 and at least one shortcut 15 are arranged on the track 13 to form a plurality of paths 16. In FIG. 1, only one path 16 is illustrated, and one shortcut 15 is taken as an example for illustration, but the present application is not limited thereto.

More specifically, a width of the track 13 allows a plurality of the physical objects 20 to move forward side by side. The plurality of obstacles 14 have various shapes, such as teardrop shapes and arc shapes. When one of the plurality of physical objects 20 collides with one of the plurality of obstacles 14 or another one of the plurality of physical objects 20, an advancing direction of the physical object 20 is changed so that the physical object 20 moves forward along different paths 16. Two ends of the at least one shortcut 15 are connected to different positions of the track 13. The physical object 20 may enter the at least one shortcut 15 due to collision with a boundary of the track 13, one of the plurality of obstacles 14, or another one of the physical objects 20, so that a time required to reach the end point 12 is shortened by the at least one shortcut 15.

In one embodiment, the plurality of physical objects 20 are allowed to be propelled from the starting point 11 and pass over a highest point 131 of the track 13 by a mechanical device 21, such as a launching device or an air-blowing device, but not limited thereto. The plurality of physical objects 20 are then driven by potential energy as a power source and respectively allowed to randomly move along one of the plurality of paths 16 toward the end point 12 to thereby respectively generate an object movement trajectory 22. After the plurality of physical objects 20 reach the end point 12, a game result is generated. The game result mainly includes an order in which the plurality of physical objects 20 reach the end point 12. In other embodiments, the game result may further include a time at which the plurality of physical objects 20 reach the end point 12, but is not limited thereto.

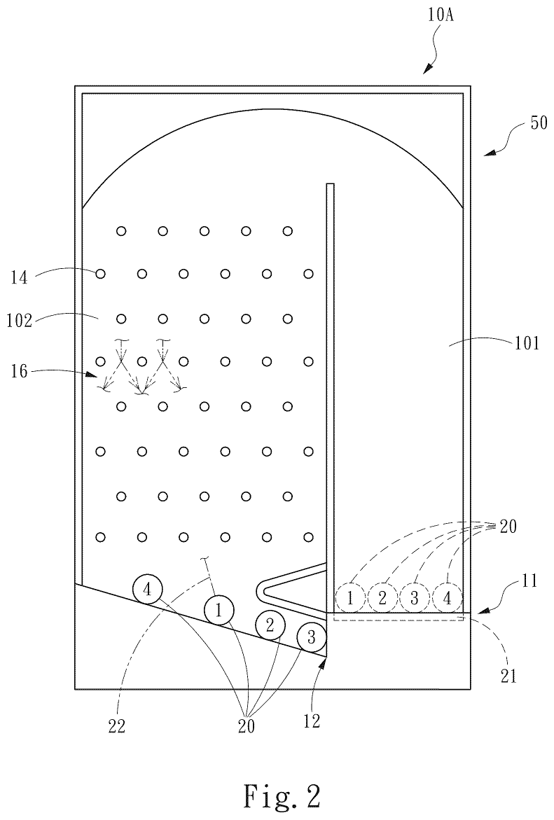

Referring to FIG. 2, a physical gaming machine 10A of another embodiment of the random path game is illustrated. The physical gaming machine 10A is in a pinball-machine form and is likewise configured to have a starting point 11 and an end point 12. The plurality of physical objects 20 are a plurality of marbles, and four marbles are illustrated in the drawing as an example. The physical gaming machine 10A includes an ascending slope section 101 and a descending slope section 102 connected to each other. The descending slope section 102 is provided with a plurality of obstacles 14, and a plurality of paths 16 are formed among the plurality of obstacles 14. In FIG. 2, only some of the plurality of paths 16 in a partial area are illustrated. The starting point 11 is provided at a bottom of the ascending slope section 101. The plurality of physical objects 20 are allowed to be propelled from the starting point 11 by the mechanical device 21, such as a launching device, an air-blowing device, or the like, and pass through the ascending slope section 101 to enter the descending slope section 102. The end point 12 is provided at a bottom of the descending slope section 102. Accordingly, the plurality of physical objects 20 are driven by potential energy as a power source and collide with the plurality of obstacles 14 during a descending process so as to randomly reach the end point 12 along the plurality of paths 16, thereby respectively generating the object movement trajectory 22. After the plurality of physical objects 20 reach the end point 12, a game result is generated, wherein the game result includes an order in which the plurality of physical objects 20 reach the end point 12.

In other embodiments, the physical gaming machine of the random path game may be configured to have one starting point and a plurality of end points, or a plurality of starting points and one end point, or a plurality of starting points and a plurality of end points. The plurality of physical objects may start from the same or different starting points and randomly move toward one of the plurality of end points. Accordingly, interest, excitement, and variation of the game are increased, thereby satisfying preferences of different players.

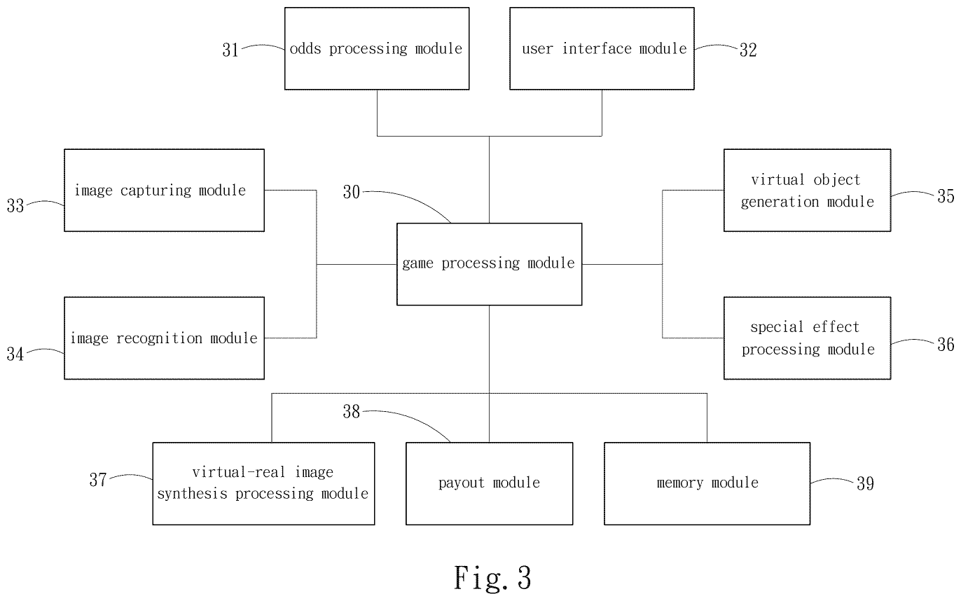

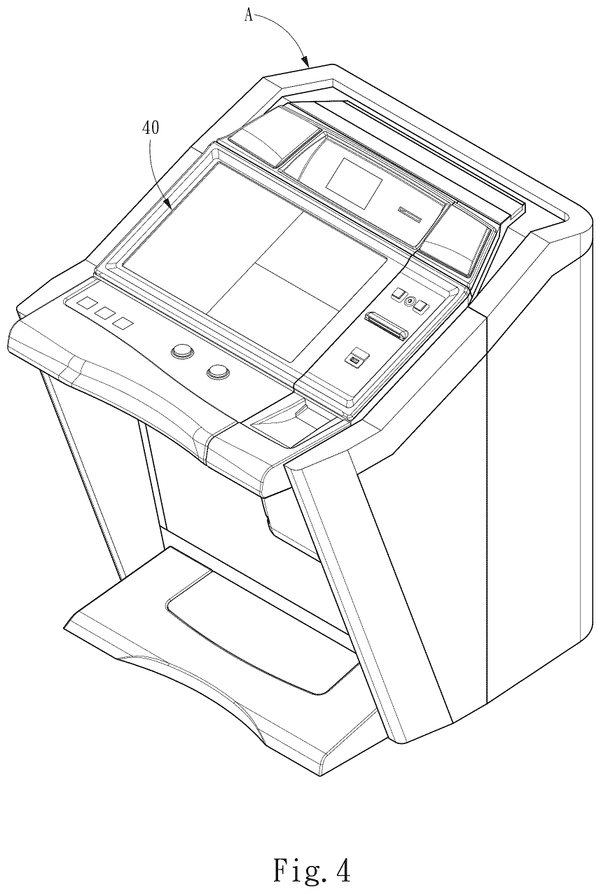

Referring to FIGS. 3, 4, and 5, in one embodiment, the virtual-real integrated system includes a game processing module 30, an odds processing module 31, a user interface module 32, an image capturing module 33, an image recognition module 34, a virtual object generation module 35, a special effect processing module 36, a virtual-real image synthesis processing module 37, a payout module 38, and a memory module 39. The game processing module 30 controls operation of the random path game. More specifically, the game processing module 30 is connected to the odds processing module 31, the user interface module 32, the image capturing module 33, the image recognition module 34, the virtual object generation module 35, the special effect processing module 36, the virtual-real image synthesis processing module 37, the payout module 38, and the memory module 39. The game processing module 30 operates in coordination with the foregoing modules and transmits commands, data, and the like required for operation of the modules, so as to control operation of the random path game.

The user interface module 32 displays a game screen display area 321 and a plurality of betting areas 322, wherein the plurality of betting areas 322 respectively correspond to the plurality of physical objects 20. In one embodiment, the user interface module 32 is a touch screen 40 and is configured on a gaming machine A. In other embodiments, the user interface module 32 may also be configured on an electronic device, such as a computer, a smartphone, or a tablet device, so that the player is able to perform operations via a remote connection through the Internet, but is not limited thereto.

The odds processing module 31 provides a set of payout odds according to real-time positions of the plurality of physical objects 20. The set of payout odds includes a plurality of payout odds respectively applicable to the plurality of physical objects 20, so that the player is able to place bets on the plurality of physical objects 20. The set of payout odds may be provided by the odds processing module 31 when the plurality of physical objects 20 are located at a same position, such as the starting point 11, or when the plurality of physical objects 20 are located at different positions, such as different positions in the plurality of paths 16, which will be described in detail below.

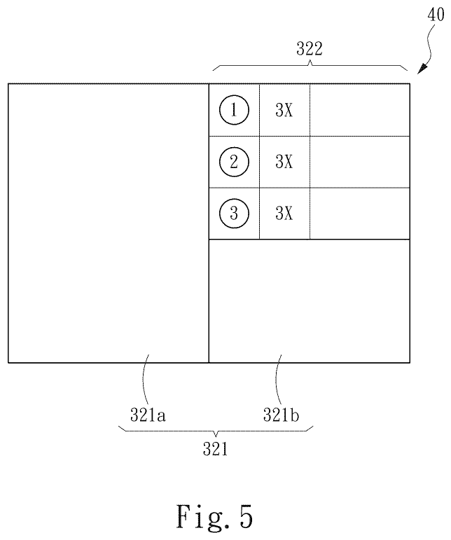

In one embodiment, real-time positions of the plurality of physical objects 20 are all located at a same position. As shown in the physical gaming machine 10 of FIG. 1 or the physical gaming machine 10A of FIG. 2, before the game starts, the plurality of physical objects 20 are all located at the starting point 11. At that time, the plurality of payout odds applicable to the plurality of physical objects 20 have an identical value. As shown in FIG. 5, the plurality of payout odds are all 3X, wherein X is an indication representing odds. Accordingly, the player can obtain a payout at 3X odds if the player correctly bets on the physical object 20 that reaches first. In addition, the odds herein are preset values and are provided only as an example, rather than actual application data. Actual data are determined according to the quantity of the plurality of physical objects 20, regulatory requirements, and requirements of operating profit.

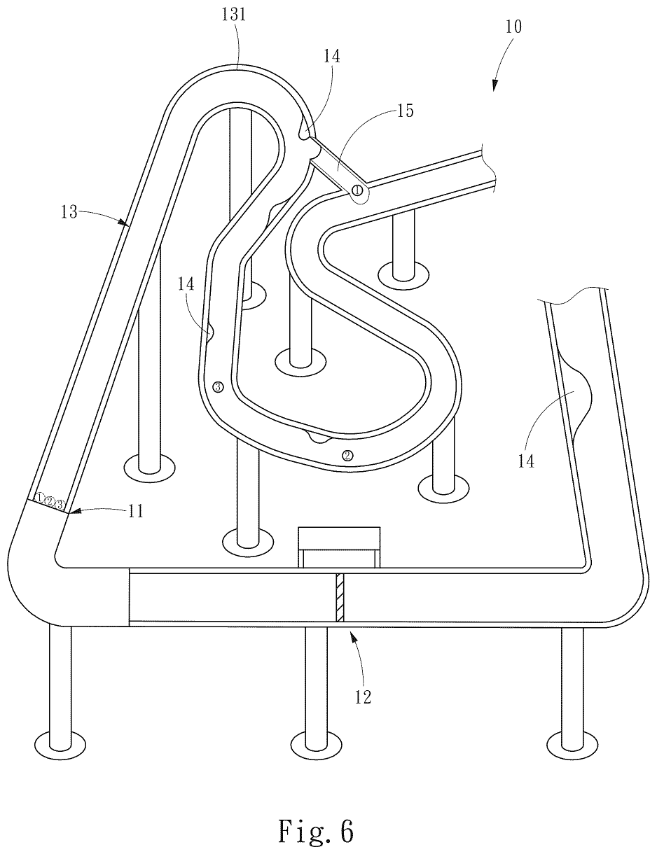

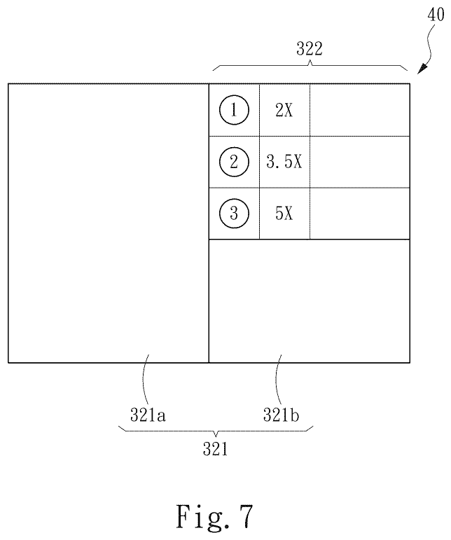

In another embodiment, as shown in the physical gaming machine 10 of FIG. 1, when the real-time positions of the plurality of physical objects 20 are located at different positions after a period of time from the start of the game, the odds processing module 31 may provide the set of payout odds for “intermediate betting.” For example, after the game proceeds for a period of time, the plurality of physical objects 20 are located at different positions due to collision with each other and differences in the plurality of paths 16 along which each of the plurality of physical objects 20 moves. The plurality of payout odds in the set of payout odds provided by the odds processing module 31 are assigned corresponding values according to the real-time positions of the plurality of physical objects 20, relative distances among the physical objects 20, ranking order of any one of the physical objects 20, and distances of the physical objects 20 relative to the end point 12. For example, as shown in FIGS. 6 and 7, the payout odds of the plurality of physical objects 20 numbered “1”, “2”, and “3” may be changed from 3X to 2X, 3.5X, and 5X according to the ranking order. Since the physical object 20 numbered “1” enters the shortcut 15 and is closest to the end point 12, the physical object 20 numbered “1” is estimated to reach the end point 12 first, and therefore the payout odds thereof are reduced to 2X. Since probabilities of the physical objects 20 numbered “2” and “3” being estimated to reach the end point 12 first are reduced, the payout odds thereof are increased to 3.5X and 5X.

When the set of payout odds for “intermediate betting” is provided by the odds processing module 31, in one embodiment, the plurality of payout odds are displayed and updated in real-time on the plurality of betting areas 322, so that the player is able to recognize the payout odds of the physical objects 20 and conveniently place bets.

Accordingly, after the plurality of payout odds are displayed and updated in real-time by the user interface module 32 on the plurality of betting areas 322 in the physical gaming machine 10 shown in FIG. 1, the player is able to place another bet, thereby avoiding boredom caused by waiting for the game result for a long period of time.

It should be noted that the embodiment in which the odds processing module 31 provides the set of payout odds for “intermediate betting” is applicable only to the physical gaming machine 10 shown in FIG. 1, and is not applicable to the physical gaming machine 10A shown in FIG. 2. This is because the physical gaming machine 10 shown in FIG. 1 has a sufficiently long game duration, such that the odds processing module 31 is able to provide the set of payout odds for “intermediate betting” for the player to play. However, the physical gaming machine 10A shown in FIG. 2 has a short game duration, and does not have sufficient time for the odds processing module 31 to provide the set of payout odds for “intermediate betting.”

In addition, when the set of payout odds for “intermediate betting” is provided by the odds processing module 31, the plurality of payout odds in the set of payout odds may become inappropriate as the game proceeds. For example, for the physical object 20 ranked last, the payout odds are assigned the highest value. However, as the game proceeds, once the physical object 20 ranked last surpasses the other physical objects 20, the payout odds become inappropriate. At this time, it is no longer suitable to continue generating the betting data based on bets placed on the plurality of betting areas 322. Accordingly, only within a designated period during which the set of payout odds is provided, the game processing module 30 is limited to generate the betting data based on bets placed on the plurality of betting areas 322.

For example, when the plurality of physical objects 20 are all located at the starting point 11, a last time point of the designated period corresponds to a time point at which the game starts. When the plurality of physical objects 20 are not located at the starting point 11, that is, in the embodiment in which the odds processing module 31 provides the set of payout odds for “intermediate betting,” the designated period lasts only for a short period of time, such as 5 seconds or 8 seconds.

In addition, for the physical gaming machine 10 shown in FIG. 1, the odds processing module 31 is configured to provide the set of payout odds at intervals in a cyclic manner. For example, the set of payout odds may be provided every 90 seconds, thereby avoiding boredom of the player and increasing an amount of bets placed by the player during the game. In other embodiments, the odds processing module 31 is configured to provide the set of payout odds when distances among the physical objects 20 have a significant change. When the distances among the physical objects 20 have a significant change, values of the corresponding payout odds also have significant differences. Accordingly, an effect of attracting the player to place bets is achieved. In addition, when any one of the physical objects 20 is estimated to reach the end point 12 within the time interval, the odds processing module 31 stops providing the set of payout odds.

During the game, the game processing module 30 is configured to generate betting data based on the plurality of betting areas 322. The betting data includes a betting selection and a betting amount. That is, the betting data refers to a betting status of the player on one or more of the physical objects 20. The betting selection and the betting amount respectively correspond to at least one of the plurality of physical objects 20. The betting selection indicates the at least one physical object 20 selected by the player for placing bets. The betting amount indicates an amount placed on the at least one physical object 20 on which the bet is placed. The applicable set of payout odds is the set of payout odds provided by the odds processing module 31 at a time point when the betting data is generated by the game processing module 30 after the bet is placed by the player.

In one embodiment, the set of payout odds has a return-to-player (RTP) rate. After the betting data is generated, the odds processing module 31 generates a plurality of variable odds, wherein the plurality of variable odds have a plurality of selection probabilities correspondingly. The odds processing module 31 causes at least one of the plurality of payout odds to be replaced by the plurality of variable odds in a many-to-one manner according to the selection probabilities of the variable odds. That is, each of the payout odds in the set of payout odds may be replaced by one of the plurality of variable odds, thereby increasing a variation of values of the payout odds.

In practice, the plurality of variable odds may form a group corresponding to one of the payout odds to be replaced, and a sum of the selection probabilities of the plurality of variable odds in the group is 100%. That is, the plurality of variable odds generated by the odds processing module 31 may be divided into a plurality of groups corresponding to a plurality of payout odds. When at least one of the plurality of payout odds is replaced by the plurality of variable odds in a many-to-one manner, the RTP is caused to have a variation value accordingly.

In one embodiment, a portion of the plurality of variable odds is lower than the corresponding ones of the payout odds.

In one embodiment, each of the variable odds generated by the odds processing module 31 and the selection probability thereof must satisfy a requirement that the variation value of the RTP is minimized.

In one embodiment, the odds processing module 31 determines at least one of an upper limit, a lower limit, and a quantity of the plurality of variable odds in advance, and generates the plurality of variable odds accordingly. More specifically, the odds processing module 31 determines at least one of the upper limit, the lower limit, and the quantity of the plurality of variable odds according to a system default or player input, thereby reducing computational complexity for generating the plurality of variable odds.

The upper limit and the lower limit of the plurality of variable odds are respectively a highest value and a lowest value that the plurality of variable odds may have. The quantity of the plurality of variable odds is a number of possible values of the plurality of variable odds. In one embodiment, the upper limit of the plurality of variable odds is not greater than two times an original odds value, the lower limit is not less than 60% of the original odds value, and the quantity is 2 to 4, but is not limited thereto.

More specifically, the odds processing module 31 generates the quantity, values, and selection probabilities of the plurality of variable odds by using random numbers. The odds processing module 31 then adjusts the values and the selection probabilities of the plurality of variable odds by using a trial-and-error method until the variation value of the RTP is minimized. That is, a difference between an RTP obtained by applying the plurality of variable odds and the corresponding selection probabilities and an RTP obtained by applying the payout odds is minimized. In other words, the variation value of the RTP is obtained based on the difference between the RTP corresponding to the set of payout odds and that corresponding to the plurality of variable odds and the selection probabilities.

Accordingly, provision of the plurality of variable odds and the corresponding selection probabilities is completed. In one embodiment, the values of the plurality of variable odds are varied in units of integers or 0.5, so that the player is able to clearly recognize changes in the values of the plurality of variable odds.

For example, a value of the payout odds for each of the physical objects 20 reaching the end point 12 first may be set to 3X. An example of the plurality of variable odds generated by the odds processing module 31 is shown in Table 1.

TABLE 1

| variable odds | 2X | 3X | 5X | 6X |
|---|---|---|---|---|
| probabilities of being selected | 50% | 30% | 10% | 10% |

The plurality of variable odds and the corresponding selection probabilities are 2X, 50%; 3X, 30%; 5X, 10%; and 6X, 10%, and form a group. One of the plurality of variable odds is selected according to the selection probabilities to replace the payout odds. An average value of the replaced variable odds is calculated to be 3 (i.e., 2*50%+3*30%+5*10%+6*10%). Since the average value of the replaced variable odds is 3X, which is the same as the preset payout odds of 3X, the expected RTP remains unchanged. Accordingly, the variation value is 0, thereby satisfying a requirement that the variation value of the RTP is minimized.

When at least one of the payout odds in the set of payout odds is replaced by one of the plurality of variable odds, the player has an opportunity to obtain a higher reward. For example, in the set of payout odds, the original payout odds of the physical objects 20 numbered 1, 2, 3, and 4 are (3X, 3X, 3X, 3X), respectively. After the payout odds of the physical objects 20 numbered 1, 2, 3, and 4 are each replaced by one of the plurality of variable odds, the payout odds in the set of payout odds may become (2X, 3X, 5X, 6X). Accordingly, the player has an opportunity to obtain a higher reward.

In addition, in one embodiment, the memory module 39 is configured to store a plurality of odds tables. The plurality of odds tables respectively record the plurality of variable odds. The plurality of odds tables stored in the memory module 39 may be provided in advance by random numbers or may be input and stored in the memory module 39, thereby avoiding computational complexity and difficulty. After the game processing module 30 receives an activation signal, one of the plurality of odds tables is activated. The activation signal may be generated by input through the user interface module 32, or one of the plurality of odds tables may be preset to be activated according to a preset default value. In other words, the odds table to be used for playing the game may be selected and activated by the player.

The game processing module 30 controls the odds processing module 31 to replace at least one of the plurality of payout odds with the plurality of variable odds recorded in the activated odds table in a many-to-one manner. A portion of the plurality of variable odds recorded in each of the odds tables is lower than the corresponding ones of the payout odds. Accordingly, on the premise that the variation value of the RTP is minimized, the payout odds have an opportunity to be replaced by variable odds having a higher odds value, thereby increasing volatility of the game provided by the game system of the present application and further attracting the player to play the game.

In other embodiments, the plurality of variable odds is greater than or equal to corresponding ones of the payout odds.

In one embodiment, each of the variable odds and the selection probability thereof meets a requirement that the variation value of the RTP is increased by a designated value.

For example, a value of the payout odds for each of the physical objects 20 reaching the end point 12 first may be set to 2X. In this embodiment, a corresponding RTP may be calculated as ¼×2=50%. The designated value may be set or adjusted according to operating profit requirements or regulatory requirements. In one embodiment, the designated value is set such that the RTP is not less than 85% as required by regulations. Accordingly, the designated value may be set to 37.5%, such that the variable odds and the corresponding selection probabilities satisfy a requirement that the RTP is increased to 87.5%.

An example of the plurality of variable odds generated by the odds processing module 31 is shown in Table 2.

TABLE 2

| variable odds | 2X | 3X | 5X | 8X |
|---|---|---|---|---|
| probabilities of being selected | 40% | 30% | 20% | 10% |

The plurality of variable odds and the corresponding selection probabilities are 2X, 40%; 3X, 30%; 5X, 20%; and 8X, 10%, and form a group. One of the plurality of variable odds is selected according to the selection probabilities to replace the payout odds. An average value of the replaced variable odds is calculated to be 3.5 (i.e., 2×40%+3×30%+5×20%+8×10%). Accordingly, the RTP is calculated as ¼×3.5≈87.5%, thereby satisfying a requirement that the RTP is increased to 87.5%.

In addition, in one embodiment, the memory module 39 is likewise configured to store the plurality of odds tables, wherein the plurality of odds tables respectively record the plurality of variable odds. The plurality of odds tables stored in the memory module 39 may be generated in advance by random numbers or may be input and stored in the memory module 39. The plurality of variable odds recorded in the odds tables are greater than or equal to the payout odds correspondingly, thereby avoiding computational complexity and difficulty, and in particular reducing a computational burden on developers.

Accordingly, when at least one of the payout odds in the set of payout odds is replaced by one of the plurality of variable odds, the player has an opportunity to obtain a higher reward. For example, in the set of payout odds, the original payout odds of the physical objects 20 numbered 1, 2, 3, and 4 are (2X, 2X, 2X, 2X), respectively. After the payout odds of the physical objects 20 numbered 1, 2, 3, and 4 are each replaced by one of the plurality of variable odds, the payout odds in the set of payout odds may become (2X, 4X, 5X, 8X).

Accordingly, the values of the payout odds are maintained or increased without being decreased. That is, in this embodiment, none of the plurality of payout odds is replaced by lower variable odds. Accordingly, replacement of the payout odds by lower variable odds, which may result in a decrease in the values of the payout odds, is avoided. Accordingly, a perception that the values of the payout odds are “reduced” is further avoided, thereby increasing a level of trust of the player in the game system of the present application.

When all of the plurality of payout odds are each selected according to the selection probabilities of the variable odds and are replaced by the variable odds in a many-to-one manner, it should be noted that when any of the variable odds, selected according to the selection probabilities, is identical to a corresponding one of the plurality of payout odds (for example, variable odds of 2X replaces payout odds of 2X), the odds processing module 31 may treat such a case as the variable odd “replacing” the payout odd, or may treat such a case as the variable odd “not replacing” the payout odd, and the present application is not limited thereto.

Referring further to FIGS. 2 and 3, the image capturing module 33 captures a real scene of the physical gaming machine 10A to obtain a real-time image 50, and transmits the real-time image 50 to the game processing module 30. The image capturing module 33 includes one or more cameras. The one or more cameras are typically disposed at a higher position to capture a panoramic view of the physical gaming machine 10A, such that the captured real-time image covers the entire physical gaming machine 10A. In other embodiments, a plurality of cameras of the image capturing module 33 may be disposed at different positions of the physical gaming machine 10A, and different images may be generated from multiple viewing angles to form the real-time image 50.

The game processing module 30 transmits the real-time image 50 to the image recognition module 34, so that the image recognition module 34 performs recognition and analysis on the real-time image 50 to generate image position information. The image position information includes a position of the physical gaming machine 10A and positions of the plurality of physical objects 20. The image recognition module 34 then transmits the image position information back to the game processing module 30.

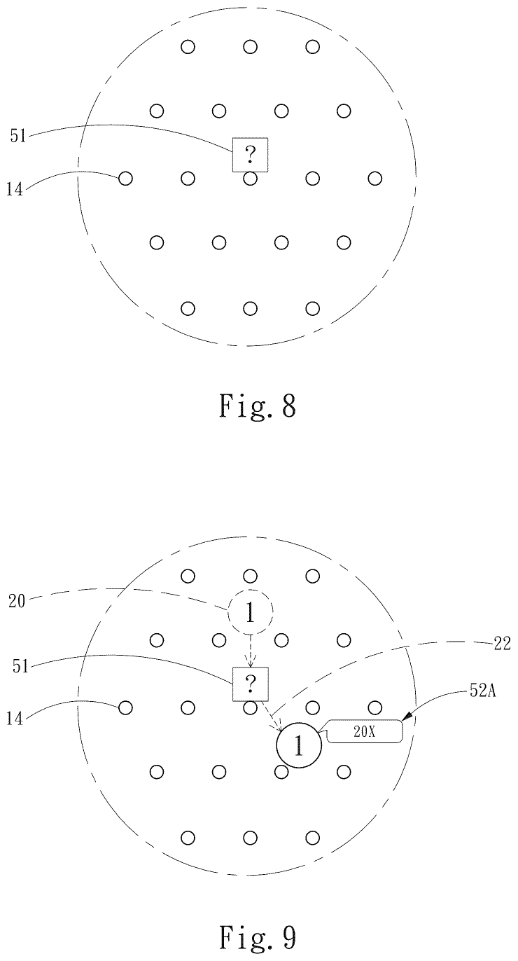

Referring further to FIGS. 2, 3, and 8, in order to increase excitement and uncertainty of the game, the virtual object generation module 35 randomly generates at least one virtual object image 51 after the betting data is generated. The at least one virtual object image 51 randomly appears on the plurality of paths 16, and each of the at least one virtual object image 51 has corresponding virtual object position information, wherein a position of the virtual object position information is located on the plurality of paths 16.

Referring further to FIGS. 2, 3, 9, 10, and 11, when the game processing module 30 detects that an object movement trajectory 22 of any of the plurality of physical objects 20 passes through the at least one virtual object image 51 on the plurality of paths 16, a trigger event is triggered. In one embodiment, the trigger event is, according to an attribute of the passed virtual object image 51, selected from one of an increased-odds reward, a fixed-amount reward, and an additional game reward, but is not limited thereto.

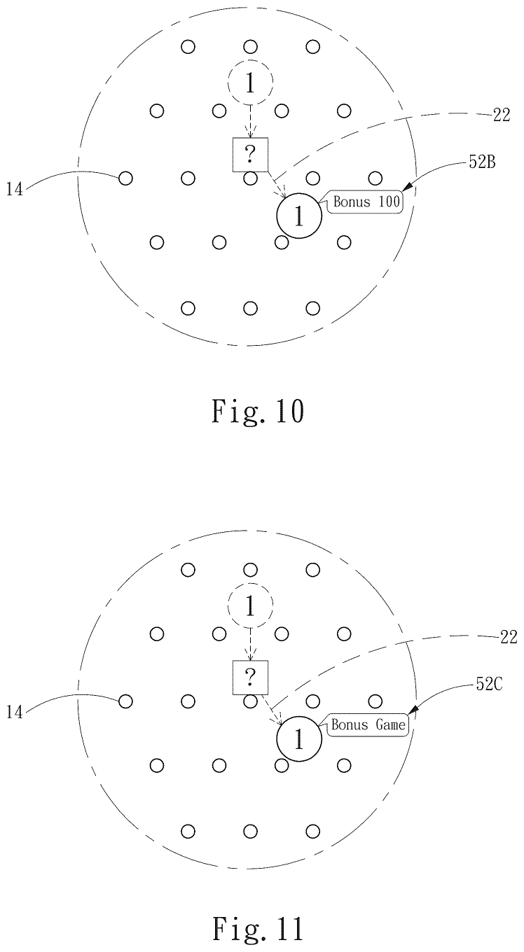

At the same time, the game processing module 30 controls the special effect processing module 36 to provide corresponding visual images 52A, 52B, and 52C according to the attribute of the virtual object image 51 through which the object movement trajectory 22 passes. For example, when the attribute of the virtual object image 51 is the increased-odds reward, as shown in FIG. 9, the visual image 52A is a value of the increased-odds reward, such as 20X. When the attribute of the virtual object image 51 is the fixed-amount reward, as shown in FIG. 10, the visual image 52B is an amount of the fixed-amount reward, such as Bonus 100. When the attribute of the virtual object image 51 is the additional game reward, as shown in FIG. 11, the visual image 52C is a name of the additional game reward, such as Bonus Game.

In one embodiment, the increased-odds reward may be randomly selected from an increased-odds table, wherein the increased-odds table records a plurality of increased odds, and the plurality of increased odds respectively have corresponding selection probabilities for being used as the increased-odds reward. As shown in Table 3, the higher the value of the increased odds, the lower the corresponding selection probability. Accordingly, while maintaining a possibility for the player to obtain a high reward, operating profit can still be maintained.

TABLE 3

| increased odds | 2X | 5X | 10X | 20X |
|---|---|---|---|---|
| probabilities of being selected | 80% | 17% | 2% | 1% |

In another embodiment, the increased-odds reward is likewise selected from an increased-odds table, wherein the increased-odds table records a plurality of increased odds having different contents, and the plurality of increased odds respectively have selection conditions for being used as the increased-odds reward. Each of the selection conditions corresponds to a ranking order of the physical object 20 that triggers the trigger event in the random path game. In other words, the physical object 20 that triggers the trigger event obtains a corresponding increased-odds reward according to the ranking order.

For example, as shown in Table 4, when the ranking order of the physical object 20 is 1st, the increased-odds reward of 2X is obtained; when the ranking order is 2nd, the increased-odds reward of 5X is obtained; when the ranking order is 3rd, the increased-odds reward of 10X is obtained; and when the ranking order is 4th, the increased-odds reward of 20X is obtained. Since a probability that the physical object 20 having a lower ranking order eventually becomes first to reach the end point 12 is low, a higher value of the increased-odds reward may be assigned, thereby attracting attention of the player while maintaining operating profit.

TABLE 4

| increased odds | 2X | 5X | 10X | 20X |
|---|---|---|---|---|
| ranking order of the physical object | 1st | 2nd | 3rd | 4th |

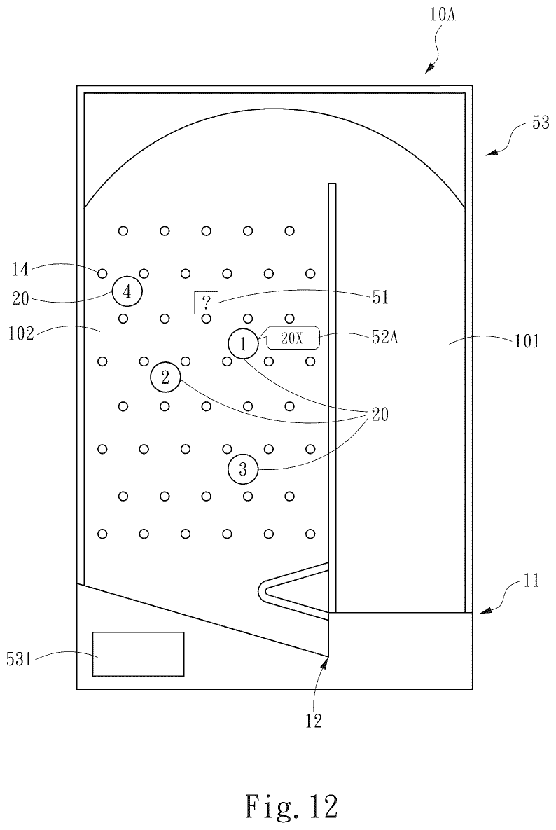

Referring further to FIGS. 2, 3, 5, and 12, the game processing module 30 transmits the real-time image 50 of the physical gaming machine 10A, the image position information, the at least one virtual object image 51, the at least one virtual object position information, the visual images 52, and the betting data to the virtual-real image synthesis processing module 37, and controls the virtual-real image synthesis processing module 37 to generate a virtual-real synthesized image 53 accordingly. The game processing module 30 then transmits the virtual-real synthesized image 53 to the user interface module 32, so that the game screen display area 321 of the user interface module 32 displays the virtual-real synthesized image 53.

Through presentation information of the virtual-real synthesized image 53, the player is able to simultaneously recognize the real-time image 50 of the random path game, the virtual object images 51 that appear, and the visual images 52 generated by the trigger events without switching between different viewing screens, thereby effectively extending a duration for which the player plays the game.

In one embodiment, the virtual-real image synthesis processing module 37 further displays a virtual board 531 in the virtual-real synthesized image 53. The virtual board 531 is virtually generated by the virtual-real image synthesis processing module 37 and is used to display the betting amounts of the physical objects 20. Accordingly, the player is able to promptly recognize the betting amounts corresponding to the physical objects 20 and recognize betting conditions of the physical objects 20.

In one embodiment, as shown in FIG. 5, the game screen display area 321 includes a public display field 321a and a personal display field 321b. The public display field 321a displays the virtual-real synthesized image 53, and the personal display field 321b displays personal information of the player. When the player obtains the additional game reward, the additional game reward is a bonus game, and a game process of the bonus game is displayed on the personal display field 321b. The bonus game may be a free bonus game without betting, and the bonus game is executed on the personal display field 321b in a fully automatic manner or under control of the player. In order to attract attention of other players, in one embodiment, the public display field 321a may also simultaneously display the game process of the bonus game. In other embodiments, whether the public display field 321a simultaneously displays the game process of the bonus game may be determined under control of the player.

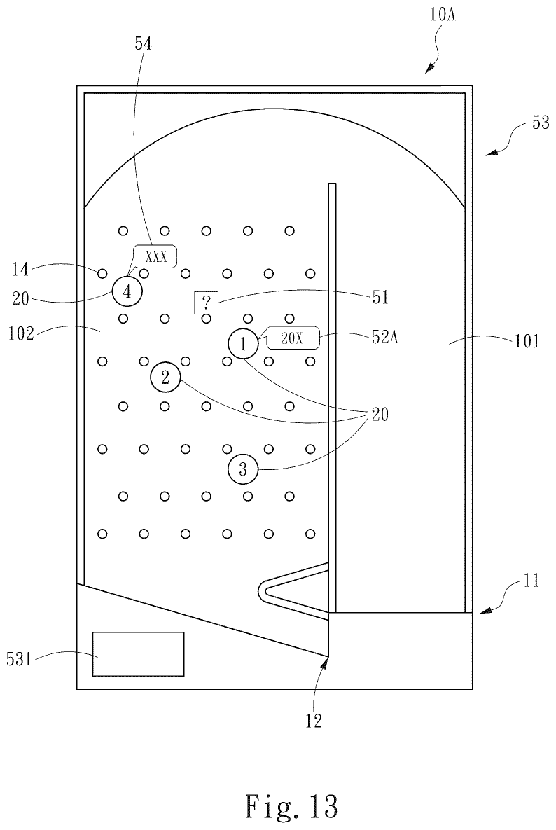

Referring further to FIG. 13, in one embodiment, the visual image 52A moves along with the corresponding physical object 20. Accordingly, it can be clearly indicated which physical object 20 has obtained the trigger event, thereby attracting attention of the player. In other embodiments, the visual image 52A may continue to be displayed at a position of the virtual object image 51 that triggers the trigger event, so as to clearly indicate a position at which the trigger event occurs.

In one embodiment, when the at least one virtual object image 51 is generated, the at least one virtual object image 51 is limited to appear between the real-time positions of the plurality of physical objects 20 and the end point 12. Accordingly, after the at least one virtual object image 51 is generated, a probability that the at least one virtual object image 51 is passed by one of the plurality of physical objects 20 is ensured, thereby avoiding doubts that the game intentionally controls a generation position of the at least one virtual object image 51 and maintaining fairness of the game.

In addition, as shown in FIG. 13, when the virtual-real image synthesis processing module 37 synthesizes the virtual-real synthesized image 53, an annotation image 54 is displayed on each of the physical objects 20 with the betting selection. In one embodiment, the annotation image 54 indicates the player who places bets on the physical objects 20, for example, by displaying a player nickname, such as “XXX”, so that the player is able to recognize real-time positions of the physical objects 20 on which bets are placed. In one embodiment, the annotation image 54 moves along with each of the physical objects 20 and is continuously displayed. In another embodiment, the annotation image 54 may be displayed in a manner of being shown for a period of time and hidden for a period of time. In another embodiment, whether the annotation image 54 is displayed may be determined according to a command of the player. In another embodiment, the annotation image 54 may be displayed for the player placing the bet on that physical object 20 only. For example, if a player nicknamed “A” bets on two of the physical objects 20, the annotation images 54 showing “A” would only be shown on the display area 321 for that player nicknamed “A”, and can be shown on the public display field 321a, the personal display field 321b, or a combination thereof for that player, but the present application is not limited thereto.

The payout module 38 performs payout according to the betting data, the game result, and the rewards obtained from the trigger event. It should be particularly noted that when the rewards obtained from the trigger event are increased-odds rewards, the increased-odds rewards may be used as additional rewards or extra rewards.

When the increased-odds reward is an additional reward, the player obtains both the reward of the physical objects 20 on which the player places bets and the increased-odds reward only when the physical objects 20 on which the player places bets reach the end point 12 first. Under such a condition, a value of the increased-odds reward may be significantly increased.

When the increased-odds reward is an extra reward, the player obtains the increased-odds reward regardless of whether the physical objects 20 on which the player places bets reach the end point 12 first. Under such a condition, interest of the player in whether the trigger event occurs is increased, and boredom caused by waiting for the game result is reduced.

When the rewards obtained from the trigger event are the fixed-amount reward or the additional game reward, the rewards are typically provided as extra rewards, but are not limited thereto, and may also be provided as additional rewards.

Accordingly, the present application, as compared with conventional technologies, has at least the following advantages:

1. A real-time image is obtained by capturing a real scene of a physical gaming machine through an image capturing module. At least one virtual object image randomly appearing on a plurality of paths is generated by a virtual object generation module. When an object movement trajectory of one of the plurality of physical objects passes through the at least one virtual object image, corresponding visual images are triggered. The foregoing images are then combined by a virtual-real image synthesis processing module to generate a virtual-real synthesized image, which is displayed in the game screen display area, so that the player is able to recognize multiple types of game information from a single viewing screen.

2. A design of a plurality of variable odds is provided, such that the player has an opportunity to obtain higher odds, thereby increasing excitement of the game.

3. A design of intermediate betting is provided, thereby resolving boredom caused by waiting for the game result in conventional systems.

What is claimed is:

1. A virtual-real integrated system applied to a random path game, wherein the random path game includes a physical gaming machine and a plurality of physical objects, the physical gaming machine having at least one starting point, at least one end point, and a plurality of paths, the plurality of paths respectively connecting the at least one starting point and the at least one end point, and the plurality of physical objects respectively moving from the at least one starting point to the at least one end point along one of the plurality of paths in a random manner to thereby generate object movement trajectories, and a game result being generated after the plurality of physical objects reach the at least one end point, the virtual-real integrated system comprising:
a game processing module;
an odds processing module connected to the game processing module, the odds processing module providing a set of payout odds according to real-time positions of the plurality of physical objects, the set of payout odds including a plurality of payout odds respectively applicable to the plurality of physical objects;
a user interface module connected to the game processing module, including a game screen display area and a plurality of betting areas corresponding to the plurality of physical objects, wherein the game processing module generates betting data based on bets placed on the plurality of betting areas, the betting data including a betting selection and a betting amount corresponding to at least one of the plurality of physical objects;
an image capturing module connected to the game processing module, configured to capture a real scene of the physical gaming machine to obtain a real-time image and transmit the real-time image to the game processing module;
an image recognition module connected to the game processing module, wherein the game processing module transmits the real-time image to the image recognition module to generate image position information including positions of the physical gaming machine and the plurality of physical objects, and the image recognition module transmits the image position information back to the game processing module;
a virtual object generation module connected to the game processing module, configured to randomly generate at least one virtual object image appearing on at least one of the plurality of paths after the betting data is generated, each of the at least one virtual object image having virtual object position information located on the plurality of paths;
a special effect processing module connected to the game processing module, wherein when the game processing module detects that an object movement trajectory of any of the plurality of physical objects passes through the at least one virtual object image on the plurality of paths, a trigger event is triggered, and the game processing module controls the special effect processing module to provide a corresponding visual image according to an attribute of the virtual object image;
a virtual-real image synthesis processing module connected to the game processing module, wherein the game processing module transmits the real-time image, the image position information, the at least one virtual object image, the virtual object position information, the visual image, and the betting data to the virtual-real image synthesis processing module, and the game processing module controls the virtual-real image synthesis processing module to generate a virtual-real synthesized image, and the game processing module transmits the virtual-real synthesized image to the user interface module so that the game screen display area displays the virtual-real synthesized image; and
a payout module connected to the game processing module, configured to perform payout according to the betting data, the game result, and rewards obtained from the trigger event.

2. The virtual-real integrated system of claim 1, wherein, after the betting data is generated, the odds processing module generates a plurality of variable odds, the plurality of variable odds having a plurality of selection probabilities correspondingly, and the odds processing module replaces at least one of the plurality of payout odds with the plurality of variable odds in a many-to-one manner according to the plurality of selection probabilities.

3. The virtual-real integrated system of claim 2, wherein a portion of the plurality of variable odds is lower than corresponding ones of the payout odds.

4. The virtual-real integrated system of claim 3, wherein each of the variable odds and the selection probability thereof meets a requirement that the variation value is minimized.

5. The virtual-real integrated system of claim 4, wherein the odds processing module determines at least one of an upper limit, a lower limit, and a quantity of the plurality of variable odds, and generates the plurality of variable odds accordingly.

6. The virtual-real integrated system of claim 2, wherein the plurality of variable odds is greater than or equal to corresponding ones of the payout odds.

7. The virtual-real integrated system of claim 6, wherein a variation value of a return-to-player rate (RTP) is obtained based on a difference between an RTP corresponding to the set of payout odds and that corresponding to the plurality of variable odds and the selection probabilities, and the variable odds and the selection probabilities thereof meet a requirement that the variation value of the RTP is increased by a designated value.

8. The virtual-real integrated system of claim 1, wherein the virtual-real integrated system further comprises a memory module configured to store a plurality of odds tables, and each of the odds tables records a plurality of variable odds, wherein when the game processing module receives an activation signal, one of the odds tables is activated, and the odds processing module replaces at least one of the plurality of payout odds with the plurality of variable odds recorded in the activated odds table in a many-to-one manner.

9. The virtual-real integrated system of claim 8, wherein a portion of the plurality of variable odds recorded in each of the odds tables is lower than corresponding ones of the payout odds.

10. The virtual-real integrated system of claim 8, wherein the plurality of variable odds recorded in each of the odds tables are greater than or equal to the payout odds correspondingly.

11. The virtual-real integrated system of claim 1, wherein the virtual-real image synthesis processing module displays a virtual board in the virtual-real synthesized image, and the virtual board displays betting amounts of the betting areas.

12. The virtual-real integrated system of claim 1, wherein, only within a designated period during which the set of payout odds is provided, the game processing module generates the betting data based on bets placed on the plurality of betting areas.

13. The virtual-real integrated system of claim 12, wherein the odds processing module provides the set of payout odds at intervals in a cyclic manner.

14. The virtual-real integrated system of claim 1, wherein the trigger event is selected from one of an increased-odds reward, a fixed-amount reward, and an additional game reward according to an attribute of the virtual object image.

15. The virtual-real integrated system of claim 14, wherein the increased-odds reward is randomly selected from an increased-odds table, the increased-odds table records a plurality of increased odds, and each of the increased odds has a selection probability, respectively.

16. The virtual-real integrated system of claim 14, wherein the increased-odds reward is selected from an increased-odds table, the increased-odds table records a plurality of increased odds, and each of the increased odds respectively has a selection condition corresponding to a ranking order of any one of the physical objects that triggers the trigger event.

17. The virtual-real integrated system of claim 14, wherein the game screen display area includes a public display field displaying the virtual-real synthesized image and a personal display field displaying personal information.

18. The virtual-real integrated system of claim 17, wherein the additional game reward is a bonus game, and a game process of the bonus game is displayed on the personal display field.

19. The virtual-real integrated system of claim 18, wherein the game process of the bonus game is simultaneously displayed on the public display field.

20. The virtual-real integrated system of claim 1, wherein the visual image moves along with the corresponding one of the physical objects.

21. The virtual-real integrated system of claim 1, wherein the at least one virtual object image is limited to appear only between real-time positions of the plurality of physical objects and the at least one end point when generated.

22. The virtual-real integrated system of claim 1, wherein the virtual-real image synthesis processing module displays an annotation image on each of the physical objects with the betting selection respectively.

23. The virtual-real integrated system of claim 22, wherein the annotation image is displayed on the game screen display area for a player placing a bet on the corresponding one of the physical objects only.

24. The virtual-real integrated system of claim 1, wherein the plurality of payout odds are displayed and updated in real-time on the plurality of betting areas after the set of payout odds is provided.
